(19) United States
(12) Patent Application Publication
(10) Pub. No.: US 2011/0264723 A1
(43) Pub. Date: Oct. 27, 2011

(54) SYSTEM AND METHOD FOR SUCCESSIVE MATRIX TRANSPOSES

(75) Inventor: Harish Shridhar YAGAIN, Bangalore (IN)

(73) Assignee: SAMSUNG ELECTRONICS CO., LTD., Suwon-si (KR)

(21) Appl. No.: 13/085,975

(22) Filed: Apr. 13, 2011

(30) Foreign Application Priority Data
Apr. 21, 2010 (IN) 1126/CHE/2010
Jul. 2, 2010 (KR) 10-2010-0063690

(51) Int. Cl. G06F 7/78; G06F 17/14

(52) U.S. Cl. 708/402; 708/520

(57) ABSTRACT

A system and method for successively transposing a matrix is disclosed. The device includes a plurality of data storage elements arranged as a two dimensional (2D) structure including X rows and Y columns. The device further includes write control logic coupled to the input of plurality of data storage elements for writing data in at least one virtual row. The device also includes read control logic coupled to the output of the plurality of data storage elements for reading the data from at least one virtual column, where the data write to the at least one virtual row and the data read from the at least one virtual column are performed substantially simultaneously during each cycle of operation such that the 2D structure is transposed successively with zero cycle delay between successive transposes.

### CROSS-REFERENCE TO RELATED PATENT APPLICATIONS

This application claims priority from Indian Patent Application No. 1126/CHE/2010, filed on Apr. 21, 2010 in the Indian Patent Office, and from Korean Patent Application No. 10-2010-0063690, filed on Jul. 2, 2010 in the Korean Intellectual Property Office, the entire disclosures of which are incorporated herein by reference.

### BACKGROUND

1. Field

Methods and apparatuses consistent with exemplary embodiments relate to transposing matrices, and more particularly they relate to successively transposing a matrix.

2. Description of the Related Art

Manipulation of systems of arrays of numbers has resulted in development of various matrix operations. One such matrix operation is called the transpose which has a representation as M^{T}, where M defines the matrix and T defines the transpose operation. Matrix transpose is a permutation frequently performed in linear algebra and particularly useful in finding the solution set for complex systems of differential equations.

Currently, several architectures are known in the art for transposing a matrix. One such architecture is memory based architecture. In this architecture, an entire N×N matrix is written into memory by providing a sequential address row-by-row. Further, the N×N matrix is read column-by-column from the memory. This is achieved by performing reads with appropriate addressing such that desired column elements can be read one at a time.

Alternatively, the N×N matrix can be read by reading the entire column at a single point of time in case the data width permits. However, software overhead associated with writing and reading the N×N matrix may be high. This is due to the fact that the memory based architecture needs generating appropriate addresses for accessing the data in respective rows and columns. Moreover, in the above architecture, if the memory used for writing and reading the N×N matrix is shared memory, then this can affect the throughput of the entire memory based architecture.

Another known architecture is transpose buffer based architecture which uses N×N array of register pairs, viz, white transpose buffer registers and dark transpose buffer registers. In this architecture, data is input to the white transpose buffer registers in a row-wise order till the N² white transpose buffer registers are loaded. Once the loading is complete, the data in the white transpose buffer registers is copied to the corresponding dark transpose buffer registers which are connected in column wise order.

The data is then read out from the dark transpose buffer registers and subsequently next set of data written in the white transpose buffer registers is transposed to the dark transpose buffer registers. However, in the transpose buffer architecture, there involves a latency of (N²⁺¹) clock cycles for the first matrix and one clock cycle between successive matrix transposes (e.g., when writing and read the data is one clock cycle). Further, since the transpose buffer architecture uses two sets of N² registers for transposing one block of N² data, the area requirement is high.

Dual independent transpose buffer based architecture is yet another architecture currently used in transposing a matrix. The dual independent transpose buffer based architecture includes two independent buffers, whereby both the buffers are used alternatively for successively transposing the matrix. In this architecture, the first set of data is written to the first buffer in a row wise order. The first set of data is then read from the first buffer in a column wise order. Further, a second set of data is written into the second buffer in parallel to reading of the first set of data from the first buffer.

Similarly, during the next cycle of operation, a third set of data is written to the first buffer, while the second set of data is read from the second buffer. The latency in the dual transpose buffer architecture is N² clock cycles for the first matrix and zero for successive matrix transposes (e.g., when write and read operation is one clock cycle). Although, in the dual independent transpose buffer, the latency between the successive matrix transposes is zero as compared to other known architectures, the area requirement is doubled with the use of two independent buffers.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

A system and device for successive matrix transposes is disclosed. In one aspect, a device includes data storage elements arranged as a two dimensional (2D) structure and configured to store data, where the 2D structure includes X rows and Y columns. The device includes write control logic coupled to the input of the data storage elements for writing data in at least one virtual row.

The device also includes read control logic coupled to the output of the data storage elements for reading the data from at least one virtual column. The at least one virtual row corresponds to one of the X rows and Y columns associated with the data storage elements in which data is written. The at least one virtual column corresponds to one of the X rows and Y columns associated with the data storage elements from which the written data is read. In the device, the data write to at least one virtual row and the data read from at least one virtual column are performed substantially simultaneously during each cycle of operation such that the 2D structure is transposed successively with zero cycle delay between successive transposes.

In another aspect, a two-dimensional (2D) Discrete Cosine Transform (DCT) processor includes a first one dimensional (1D) DCT processor for computing a one-dimensional transform of a N×M matrix to yield a one-dimensional N×M intermediate transform matrix. The 2D DCT processor further includes an N×M matrix transpose circuit coupled to the first 1D DCT processor for transposing said N×M matrix with zero cycle delay between successive matrix transposes. The 2D DCT processor also includes a second 1D DCT processor for computing a one-dimensional transform of an output of the N×M matrix transpose circuit to yield a desired 2D DCT.

Other features of the embodiments will be apparent from the accompanying drawings and from the detailed description that follows.

### BRIEF DESCRIPTION OF THE DRAWINGS

FIG. 1 illustrates a block diagram of a device for successively transposing a two dimensional (2D) structure, according to an exemplary embodiment.

FIG. 2 is a schematic representation showing successive matrix transposes for a 4×4 matrix performed by the device of FIG. 1, according to an exemplary embodiment.

FIG. 3 illustrates a timing diagram for four successive transposes for a 4×4 matrix, according to an exemplary embodiment.

FIG. 4 illustrates a block diagram of a 2D Discrete Cosine Transform (DCT) processor having an N×M matrix transpose circuit, according to an exemplary embodiment.

The drawings described herein are for illustration purposes only and are not intended to limit the scope of the present disclosure in any way.

### DETAILED DESCRIPTION OF EXEMPLARY EMBODIMENTS

A system and method for successive matrix transposes is disclosed. The following description is merely exemplary in nature and is not intended to limit the present disclosure, applications, or uses. It should be understood that throughout the drawings, corresponding reference numerals indicate like or corresponding parts and features.

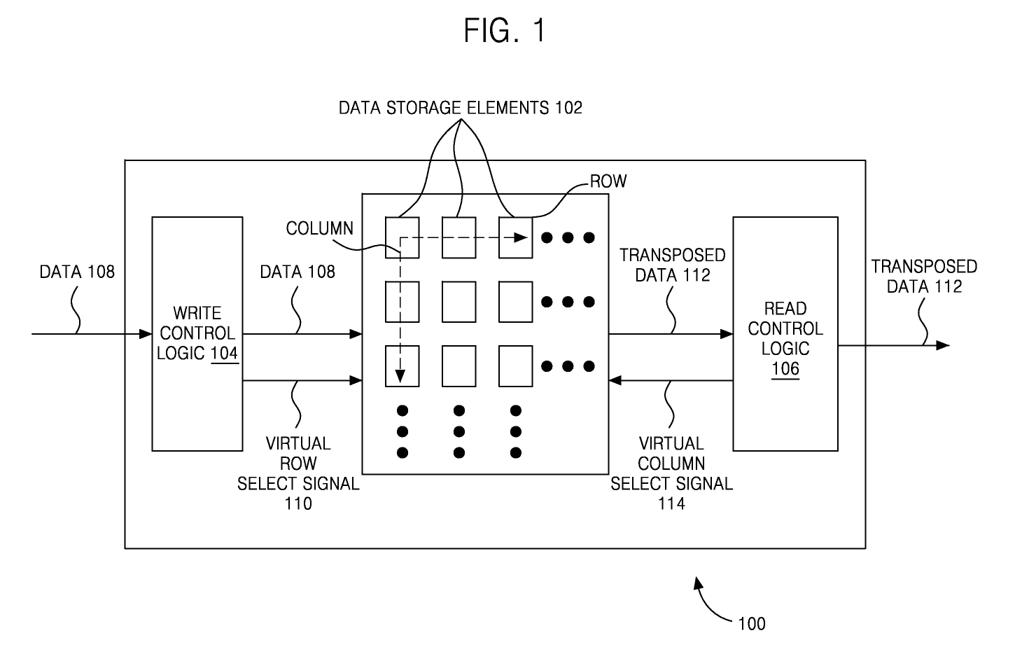

FIG. 1 illustrates a block diagram of a device 100 for successively transposing a two dimensional (2D) structure, according to an exemplary embodiment. The device 100 includes data storage elements 102, write control logic 104, and read control logic 106. The data storage elements 102 may be memory elements or registers. It will be appreciated that the data storage elements 102 may together constitute memory or a register. Each of the data storage elements 102 is configured to store a single bit or multiple bits of data (e.g., image or video data). The write control logic 104 and the read control logic 106 may include combinational logic gates and/or sequential logic elements.

The write control logic 104 is coupled to the input of the data storage elements 102. The read control logic 106 is coupled to the output of the data storage elements 102. Further, in the device 100, the data storage elements 102 are arranged as a 2D structure (e.g., a matrix). For example, the 2D structure includes X number of rows and Y number of columns.

According to an exemplary embodiment, the device 100 receives data 108 (e.g., video or image pixel data) from external means for successively transposing the data 108. For example, in case the device 100 is implemented in a 2D Discrete Cosine Transform (DCT) processor, then the device 100 may receive the data 108 from a one dimensional (1D) DCT processor of the 2D DCT processor.

In an exemplary operation, the write control logic 104 of the device 100 generates a virtual row select signal 110 to select virtual rows in the 2D structure. In one exemplary embodiment, the virtual rows may be columns or rows in the 2D structure having the set of data storage elements 102. Further, the write control logic 104 writes the data 108 to one or more of the data storage elements 102 associated with the selected virtual rows in a row wise order. In some embodiments, the write control logic 104 writes the data 108 to the rows X₁-X_{N} in the 2D structure in a row wise order during X clock cycles based on the row select signal.

Subsequently, the read control logic 106 generates a virtual column select signal 114 to select virtual columns corresponding to a set of data storage elements 102 from which the data is to be read. In one exemplary embodiment, the virtual columns may be columns or rows in the 2D structure having the set of data storage elements 102. For instance, after the completion of the first X clock cycles, i.e., during a first transpose, the virtual column select signal 114 may enable selection of the columns Y₁-Y_{N} as virtual columns. Accordingly, the read control logic 106 reads the data 108 from the data storage elements 102 associated with the columns Y1-YN in a column wise order. As a result, the data 108 in the columns Y1-YN is transposed to generate transposed data 112.

During a second transpose, the write control logic 104 generates a virtual row select signal 110 to select virtual rows for writing a new set of data 108. In this case, the virtual rows may be the column Y₁-Y_{N} (e.g., from which the data 108 is already read substantially simultaneously during the same cycle of operation). Accordingly, the write control logic 104 writes the new set of data 108 to the data storage elements 102 associated with the virtual rows in a row wise order substantially simultaneously to the read operation during the first transpose.

Further during the second transpose, the read control logic 106 generates a virtual column select signal 114 for reading the data from virtual columns. Accordingly, the read control logic 106 selects rows X_{N}-X₁ as virtual columns based on the virtual column select signal 114. Further, the read control logic 106 reads the new set of data 108 from the data storage elements 102 associated with the virtual columns in a column wise order. As a result, the data 108 in the rows X_{N}-X₁ is transposed to generate transposed data 112.

Similarly, during a third transpose, the write control logic 104 selects the rows X_{N}-X₁ as virtual rows based on a virtual row select signal 110 and writes a new set of data 108 to the data storage elements 102 associated with the virtual rows in a row wise order substantially simultaneously to the read operation during the second transpose. Further, during the third transpose, the read control logic 106 selects the columns Y_{N}-Y₁ as virtual columns and reads the data 108 from the data storage elements 102 associated with the virtual columns in a column wise order. As a result, the data 108 in the columns Y_{N}-Y₁ is transposed to generate transposed data 112.

During a fourth transpose, the write control logic 104 selects the columns Y_{N}-Y₁ as virtual rows and writes a new set of data 108 to the data storage elements 102 associated with the virtual rows in a row wise order simultaneous to the read operation in the third transpose. The device 100 thus continues the cycle for subsequent successive transposes.

It can be noted that, the device 100 performs the data reads and data writes in a cyclic order by shifting the rows and columns in a cyclic fashion. Thus, the device 100 successively transposes the data storage elements 102 arranged as a 2D structure with zero cycle delay between successive transposes, thereby providing higher throughput. It can be noted that, cyclic orientation changing of rows and columns for read and write operation assist in achieving zero cycle delay between successive transposes of the 2D structure.

It should be noted that the data storage elements 102 may include pixel data of an image or a video frame or may include coefficients representative of an image or video in a frequency domain and time domain.

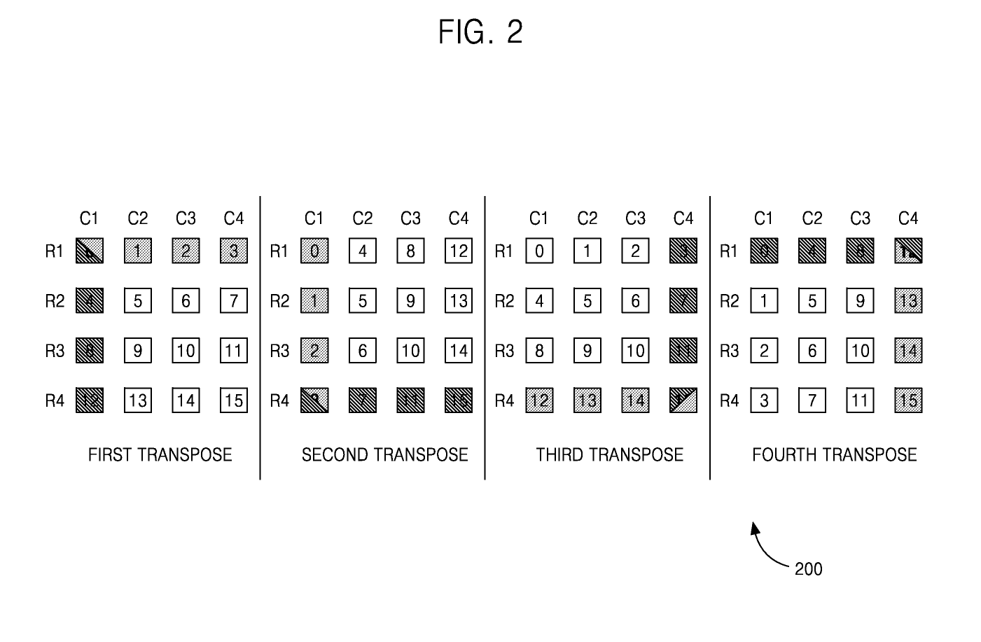

FIG. 2 is a schematic representation 200 showing successive matrix transposes for a 4×4 matrix performed by the device 100 of FIG. 1, according to an exemplary embodiment. In particular, FIG. 2 shows the order in which data read and data write occurs while successively transposing the matrices. In this example, the matrix to be transposed includes four rows and four columns, where each of the rows and columns includes four data storage elements.

As shown in FIG. 2, during the first four clock cycles, data is written in row wise order in the four rows. In one exemplary implementation, the matrix is successively transposed from the fifth clock cycle (i.e., upon completing writes in the four rows). During the first transpose, the data is read from the column C1. During the second transpose, new data is written into a virtual row, i.e., the column C1 and the data is later read from a virtual column, i.e., row R4.

During the third transpose, new data is written into a virtual row, i.e., the row R4 and the data is later read from a virtual column, i.e., column C4. During the fourth transpose, new data is written into a virtual row, i.e., the column C4 and the data is later read from a virtual column, i.e., row R1. The cycle thus continues for further matrix transposes. It can be noted that, the successive transposes of matrices is performed by cyclic orientation changing of rows and columns. This helps achieve zero cycle delay between successive matrix transposes. Although, the above description refers to data being written to or read from all the data storage element pertaining to a row or column at once per clock cycle, one can envision that data can also be written in or read from each data storage element cycle by cycle.

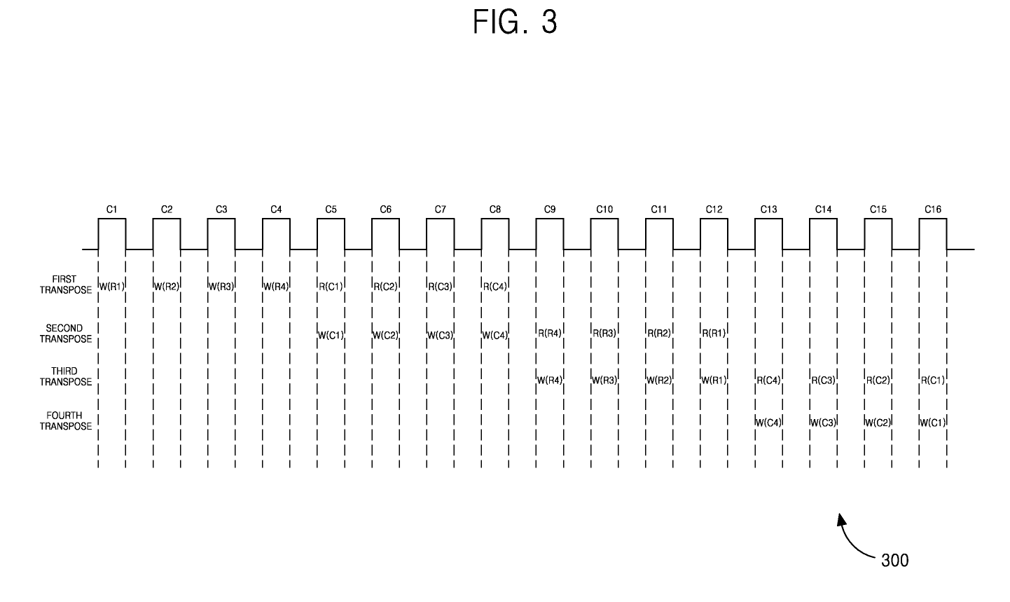

FIG. 3 illustrates a timing diagram 300 for four successive transposes for the 4×4 matrix, according to an exemplary embodiment. It can be seen in FIG. 3, during the first transpose, the data is written to the four rows (R1-R4) of the matrix in a row wise order. Once the write operation is complete, the data is read from virtual columns (i.e., columns C1-C4) in a column wise order for the next four clock cycles. During the second transpose, new data is written into virtual rows (i.e., columns C1-C4) in a row wise order simultaneous to the read operation associated with the first transpose.

Once the write operation is complete during the second transpose, the data is read from virtual columns (i.e., rows R4-R1) in a column wise order for the next four clock cycles. During the third transpose, new data is written into virtual rows (i.e., rows R4-R1) in a row wise order simultaneous to the read operation associated with the second transpose.

Once the write operation is complete during the third transpose, the data is read from virtual columns (i.e., columns C4-C1) in a column wise order for the next four clock cycles. During the fourth transpose, new data is written into virtual rows (i.e., columns C4-C1) in a row wise order simultaneous to the read operation associated with the third transpose and the cycle continues for further matrix transposes.

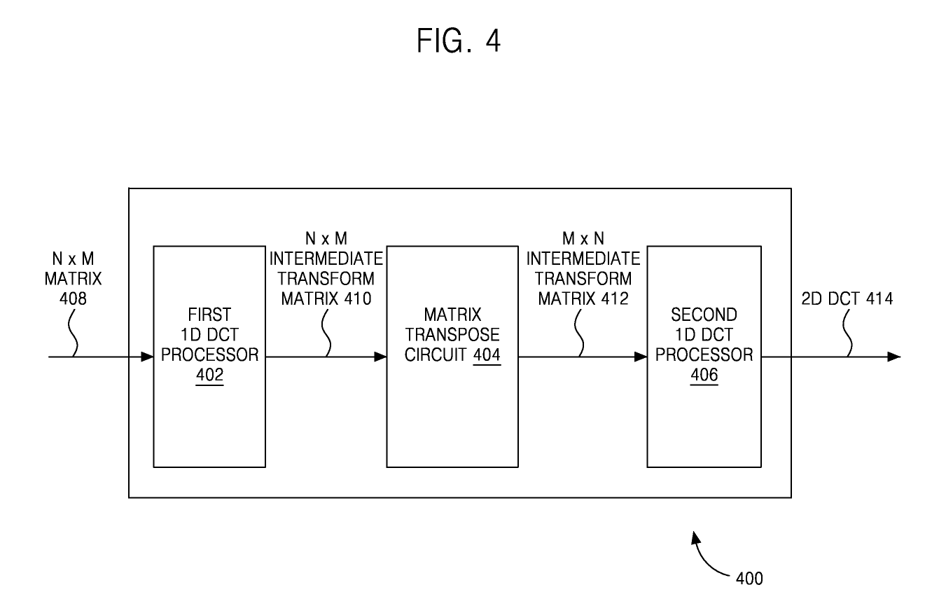

FIG. 4 illustrates a block diagram of a 2D DCT processor 400 having an N×M matrix transpose circuit 404, according to an exemplary embodiment. In FIG. 4, the 2D DCT processor 400 includes a first 1D DCT processor 402 (also referred to as row DCT processor), the N×M matrix transpose circuit 404, and a second 1D DCT processor 406 (also referred to as column DCT processor). It will be appreciated that, the N×M matrix transpose circuit 404 is the exemplary device 100 of FIG. 1. One can envision that, the device 100 can be implemented in data processing systems other than 2D DCT which requires successive transposing of matrices.

In an exemplary operation, the first 1D DCT processor 402 computes a one-dimensional transform of an N×M matrix 408 (e.g., a matrix of input data having video or image pixels encoded in 8-bit binary words) to yield an N×M intermediate transform matrix 410. Exemplarily, the one-dimensional transform of the N×M matrix 408 refers to the first 1D DCT processor 402 performing DCT operation on only rows of the N×M matrix 408 to generate the N×M intermediate transform matrix 410. The first 1D DCT processor 402 then feeds the matrix transpose circuit 404 the N×M intermediate transform matrix 410 in a row by row order. The N×M matrix transpose circuit 404 coupled to the first 1D DCT processor successively transposes said intermediate transform matrix 410 with zero cycle delay between successive matrix transposes and outputs an M×N intermediate transform matrix 412, which is a transpose of the N×M intermediate transform matrix 410.

Moreover, the second 1D DCT processor 406 computes a one-dimensional transform of said M×N intermediate transform matrix 412 to yield a desired 2D DCT 414. It can be noted that, the operation of the N×M matrix transpose circuit 404 is similar to the operation of the device 100 described in FIGS. 1-3, hence the explanation thereof is omitted. One can envision that, the 2D DCT 400 can be implemented in an image and video processing system (e.g., Joint Photographic Experts Group (JPEG) system, Moving Picture Experts Group (MPEG) system, H.264 system, etc.). It can also be envisioned that, the 2D DCT processor 400 can be implemented on a single chip.

In various embodiments, the device 100 described in FIGS. 1-3 and the device 400 described in FIG. 4 enables successive transposing of matrices with zero cycle delay between successive matrix transposes. Thus, the device 100 and the device 400 provide higher throughput and with lesser area requirement.

Aspects of the disclosed exemplary embodiments may be implemented as an entirely hardware embodiment, an entirely software embodiment (including firmware, resident software, micro-code, etc.) or an embodiment combining software and hardware aspects.

The blocks in the flowchart or block diagrams may represent a module, segment, or portion of code, which comprises one or more executable instructions for implementing the specified logical functions. Furthermore, the functions noted in the block may occur out of the order noted in the figures. Further, each block of the block diagram and/or flowchart illustration, and combinations of blocks in the block diagrams and/or flowchart illustration, can be implemented by special purpose hardware-based systems that perform the specified functions or acts, or combinations of special purpose hardware and computer instructions.

While not restricted thereto, above-described exemplary embodiments can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, exemplary embodiments may be written as computer programs transmitted over a computer-readable transmission medium, such as a carrier wave, and received and implemented in general-use or special-purpose digital computers that execute the programs.

It will be appreciated that the various exemplary embodiments discussed herein may not be the same embodiment, and may be grouped into various other embodiments not explicitly disclosed herein. In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense. It will be understood by those skilled in the art that various changes in form and details may be made to the exemplary embodiments without departing from the spirit and scope of the inventive concept described therein, as defined by the appended claims.

What is claimed is:

1. A device for transposing a two dimensional (2D) structure comprising:
a plurality of data storage elements arranged as a 2D structure and configured to store data, wherein the 2D structure includes X rows and Y columns;
write control logic coupled to an input of the plurality of data storage elements for writing data in at least one virtual row; and
read control logic coupled to an output of the plurality of data storage elements for reading the data from at least one virtual column,
wherein:
the at least one virtual row corresponds to one of the X rows and Y columns associated with the set of data storage elements in which data is written,
the at least one virtual column corresponds to one of the X rows and Y columns associated with the set of data storage elements from which the written data is read, and
data write to the at least one virtual row and the data read from the at least one virtual column are performed substantially simultaneously during each cycle of operation such that the 2D structure is transposed successively with zero cycle delay between successive transposes.

2. The device of claim 1, wherein the write control logic selects the X rows in the 2D structure for data write such that the data is written in the X rows in a row wise order during a first X cycles of operation prior to successively transposing the 2D structure.

3. The device of claim 1, wherein the data write to the at least one virtual row and the data read from the at least one virtual column are performed in a cyclic order.

4. The device of claim 2, wherein in successively transposing the 2D structure, the read control logic reads the data from virtual columns Y₁-Y_{N} in a column wise order during a first plurality of clock cycles upon completion of the first X clock cycles.

5. The device of claim 4, wherein in successively transposing the 2D structure, the write control logic writes data to virtual rows Y₁-Y_{N} in a row wise order substantially simultaneously to the reading data from the virtual columns Y₁-Y_{N} during the first plurality of clock cycles.

6. The device of claim 5, wherein in successively transposing the 2D structure, the read control logic reads, during a second plurality of clock cycles after the first plurality of clock cycles, data from virtual columns X_{N}-X₁ in a column wise order and the write control logic substantially simultaneously writes data to virtual rows X_{N}-X₁ in a row wise order.

7. The device of claim 6, wherein in successively transposing the 2D structure, the read control logic reads, during a third plurality of clock cycles after the second plurality of clock cycles, data from virtual columns Y_{N}-Y₁ in a column wise order and the write control logic substantially simultaneously writes data in virtual rows Y_{N}-Y₁ in a row wise order.

8. The device of claim 1, wherein the write control logic comprises at least one of combinational logic gates and sequential logic elements.

9. The device of claim 1, wherein the read control logic comprises at least one of combinational logic gates and sequential logic elements.

10. The device of claim 1, wherein each of the plurality of data storage elements comprises of at least single bit of data.

11. A two-dimensional (2D) Discrete Cosine Transform (DCT) processor comprising:
a first one dimensional (1D) DCT processor for computing one-dimensional transform of a N×M matrix to yield an N×M intermediate transform matrix;
an N×M matrix transpose circuit coupled to the first 1D DCT processor for transposing said N×M intermediate transform matrix with zero cycle delay between successive matrix transposes; and
a second 1D DCT processor for computing a one-dimensional transform of the output of the N×M matrix transpose circuit to yield a desired 2D DCT.

12. The 2D DCT processor of claim 11, wherein the N×M matrix transpose circuit comprises:
a plurality of data storage elements arranged as a 2D structure configured to store data associated with said intermediate transform matrix, the 2D structure comprises X rows and Y columns;
write control logic coupled to an input of the plurality of data storage elements for selecting at least one virtual row for writing data associated with said intermediate transform matrix; and
read control logic coupled to an output of the plurality of data storage elements for selecting at least one virtual column for reading the written data,
wherein:
the at least one virtual row corresponds to data storage elements corresponding to a row or column in the 2D structure in which the data is written,
the at least one virtual column corresponds to data storage elements corresponding to a row or column in the 2D structure from which the written data is read, and
the data write to the at least one virtual row and the data read to the at least one virtual column are performed substantially simultaneously during each cycle of operation such that said N×M intermediate transform matrix is transposed successively with zero cycle delay between successive matrix transposes.

13. The 2D DCT processor of claim 12, wherein the write control logic comprises at least one of combinational logic gates and sequential logic elements.

14. The 2D DCT processor of claim 12, wherein the read control logic comprises at least one of combinational logic gates and sequential logic elements.

15. The 2D DCT processor of claim 12, wherein the write control logic selects the X rows in the 2D structure for data write such that the data is written in the X rows in a row wise order during a first X cycles of operation prior to successively transposing the 2D structure.

16. The 2D DCT processor of claim 12, wherein the write control logic selects a row in the 2D structure for data write such that the data is written in the data storage elements in the selected row in Z cycles of operation, wherein the value of Z is equal to the number of data storage elements in the selected row.

17. The 2D DCT processor of claim 12, wherein the data write to the at least one virtual row and the data read from the at least one virtual column are performed in a cyclic order.

18. The 2D DCT processor of claim 12, wherein said plurality of data storage elements store data comprising video or image pixels encoded in 8-bit binary words and wherein said 2D DCT processor is implemented on a single chip.

19. A method of transposing a two-dimensional matrix including a plurality of rows and a plurality of columns, each of the plurality of rows including a plurality of row elements and each of the plurality of columns including a plurality of column elements, the method comprising:
reading a first plurality of the row elements or a first plurality of the column elements from a first row of the plurality of rows or a first column of the plurality of columns of the two-dimensional matrix during a first clock cycle;
writing new data to each of the first plurality of row elements or the second plurality of column elements which were read during the first clock cycle;
reading a second plurality of the row elements or a second plurality of the column elements from a second row of the plurality of rows or a second column of the plurality of columns of the two-dimensional matrix during a second clock cycle; and
writing new data to each of the second plurality of row elements or the second plurality of column elements which were read during the second clock cycle, wherein
each of the plurality of row elements and the plurality of column elements represent image data.

20. The method of claim 19, wherein the first clock cycle is immediately followed by the second clock cycle, the first row is adjacent to the second row, and the first column is adjacent to the second column.

21. The device of claim 1, wherein the stored data corresponds to image data.
